(19) United States
(12) Patent Application Publication
(10) Pub. No.: US 2005/0131571 A1
(43) Pub. Date: Jun. 16, 2005

(54) Internet customization of apparel

(76) Inventor: Darryl Costin, Perrysburg, OH (US)

Correspondence Address: Darryl Costin;Fractal, LLC, 29300 Clemens Road, Ste. D, Westlake, OH, 44145, US

(21) Appl. No.: 10/895,650

(22) Filed: Jul. 20, 2004

Related U.S. Application Data
(62) Division of application No. 09/227,330, filed on Jan. 6, 1999, now abandoned.
(60) Provisional application No. 60/109,580, filed on Nov. 23, 1998.

(51) Int. Cl. G06F 19/00

(52) U.S. Cl. 700/132; 705/26

(57) ABSTRACT

An Internet based technique of allowing customization of denim apparel over the Internet. The user selects custom features for their denim apparel and transmits those features to a computer run by the apparel company. The apparel company displays a facsimile of what the apparel will look like with those custom features. The user can select to purchase that apparel. If so, the company uses a laser to form the custom features on the apparel.

The present application is a divisional of U.S. application Ser. No. 09/227,330 filed Jan. 6, 1999 which claims priority to U.S. Provisional Application No. 60/109,580 filed Nov. 23, 1998.

The present system describes a method and apparatus for allowing formation of customized apparel based on user real time input via a remote terminal. More specifically, the present system describes a way of designing a unique denim garment over the internet, sending the specifications to a central processing plant, where the garment is made and delivered to the user.

### BACKGROUND

The denim industry today has one major driving force for growth—the need for new innovation and fashion. The following excerpts taken from a recent article in Daily News Record (AGlut of Basic Denim Has Mills Searching for Fashion Appeal@, Mar. 3, 1998) from leaders in the denim industry illustrate the point:

Dutch Leonard, President of Burlington Global Denim, stated ARight now there is a world oversupply of denim in basics. We are shoring up our participation in the added value segment of the denim business@. He further reports that AWe are spending a lot of time with consumers to find out what they want. What we have found is that consumers are looking for something new and different@.

Watts Carr, President of Cone Denim North America, indicates AOf course time will tell if consumers are willing to spend more for investment jeans wear, but from what we=ve heard, the apparel makers are getting into it for the long run. And I think that we will see a broad-based movement that will impact jeans wear manufacturers across the board and help fend off some of the offshore low-ball-priced business@.

Chris Glynn, Executive Vice-President of Greenwood, stated AThe only way an American mill can survive is in added-value fabrics. The market is big enough for a compromise between volume and innovation@.

John Heldrich, President and Chief Executive Officer of Swift Denim, reported that AAt Magic, there was a lot of excitement around denim. Fashion items are what are doing well. The designer segment is driving lighter weights and finishes, and newer brand names Y@

John Hudson, Jr., Executive Vice-President of Avondale, indicated that Athe key to success in today=s denim business is low-cost manufacturing and innovation@.

The denim market is crying for new denim products. Currently the denim apparel manufacturers typically offer two different shades of blue, some overdyed colors, and a number of different styles such as boot cut, slim, and wide. The inventor believes that the customer wants custom jeans and other denim products. However, there has been no technology or method to deliver such products to the mass.

Customers can typically purchase regular denim products at retail stores, mail order catalogs or even on the Internet. However, there is simply no satisfactory method to purchase denim apparel with custom features designed by the customer.

TechnoLines, LLC introduced novel laser scribing technology in which a laser is used to scribe graphic designs on denim and other materials. The laser process is described in our copending applications, including U.S. Pat. Nos. 6,104,602 and 5,916,461 the disclosures of which are herewith incorporated by reference to the extent necessary for necessary understanding. These describe ways in which a laser can be used to change the look of a garment to be processed, by intentionally damaging a surface of the material in a way that changes the look of the surface of the material. The portions of the material that are changed in this way define a pattern on the material. The marking is permanent, and is not removed by washing or by any other technique. This technique can be used to scribe an almost limitless number of graphics, logos and alphanumeric text on all areas of textile products.

The preferred textile material is a denim product, and the preferred areas include the waistband, back pocket, leg seams, thigh, etc. The marking can be used to inscribe a label on the product, or a logo, or any other feature. However, this could be scribed on many other materials, including leather, polar fleece, suede, or any other material from which apparel could be made.

This technology would allow forming custom clothing in a store, at the point of sale, if the retail outlet was equipped with the proper equipment. However, this could require expensive equipment, e.g., a numerically controlled laser, in the store. Even if the capital for such a laser were availible, space in a retail store is often at a premium.

### SUMMARY OF INVENTION

This invention discloses a technique allowing customized apparel to be ordered via a remote terminal. One preferred mode allows the selection of customized parts of an item of clothing apparel via the Internet.

This technique, called Internet kiosk, allows the customer to design unique denim apparel with custom graphics and text scribed on the denim.

According to the preferred mode, the apparel is customized on a remote terminal, that is remote from the location where the apparel will be made. The remote terminal includes the capability of commanding any of a plurality of predefined patterns, fonts, logos or other graphic indicia from a library. The user can upload any graphic indicia that is not in the library. Each of the patterns can be inscribed on the apparel in any location on the apparel, or over the entire surface of the apparel. The preferred system operates according to a menu of options. Each option can include a graphic that indicates the look of the option to be selected.

### BRIEF DESCRIPTION OF THE DRAWINGS

These and other aspects will be described in detail with respect to the accompanying drawings, in which:

FIG. 1 shows a basic overall layout of the system;

FIGS. 2-6A show screen shots of user interfaces that are displayed to the user on the screen at the remote terminal;

FIG. 6B shows sample specific graphics;

FIG. 7 shows a simulated display of the finished denim with the customization as selected;

FIG. 8 shows an order placing screen;

FIG. 9 shows selection of text for the graphic;

FIG. 10 shows the display screen for the denim with the graphic inscribed thereon;

FIG. 11 shows a laser scribing machine for forming the denim in-line on a conveyor system.

### DESCRIPTION OF THE PREFERRED EMBODIMENTS

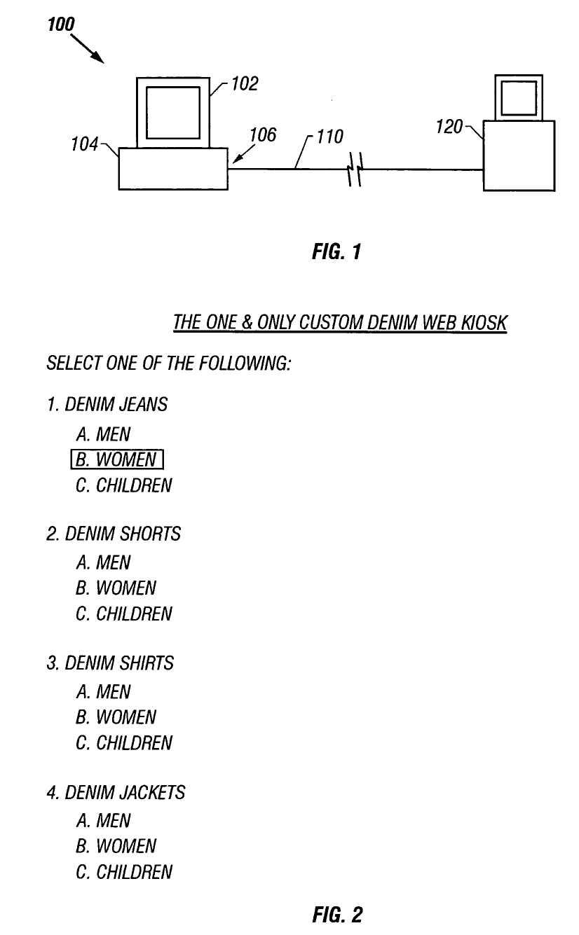

The preferred mode has the overall layout shown in FIG. 1. The remote terminal 100 is located at a spot that will be easily accessible by a user. The remote terminal includes a display 102, a local processor 104, and a connection 106 to a data link 110, e.g. a telephone line.

The other end of the data link 110 is connected to another computer, the receiving computer 120, that is located at the manufacturer=s designated location. This can be preferably located where the manufacturer intends to manufacture the apparel, or at a processing center from which outgoing orders will be sent.

A most preferred version of this embodiment uses the Internet, e.g., a secured connection, as the data link 110. However, the system can be connected by dial up modem, or by any other data transfer technique.

The apparel is customized on the remote terminal using menus that are supplied from the receiving computer. A preferred menu supplied from the receiving computer is a web page. Those menus preferably include a library of literally every possibility of apparel that can be made at the manufacturer=s processing location. The receiving computer 120 and remote terminal 100/remote computer 104 are programmed to carry out the processes described herein. These are mostly defined in terms of Ascreen shots@, defining the user interface that is displayed on the remote terminal. The screen shots can be programmed in hypertext mark up language (AHTML@), allowing the user to Aclick@ on the desired option to select it. The results of each click are recorded by the receiving computer 120, and bring up the next menu.

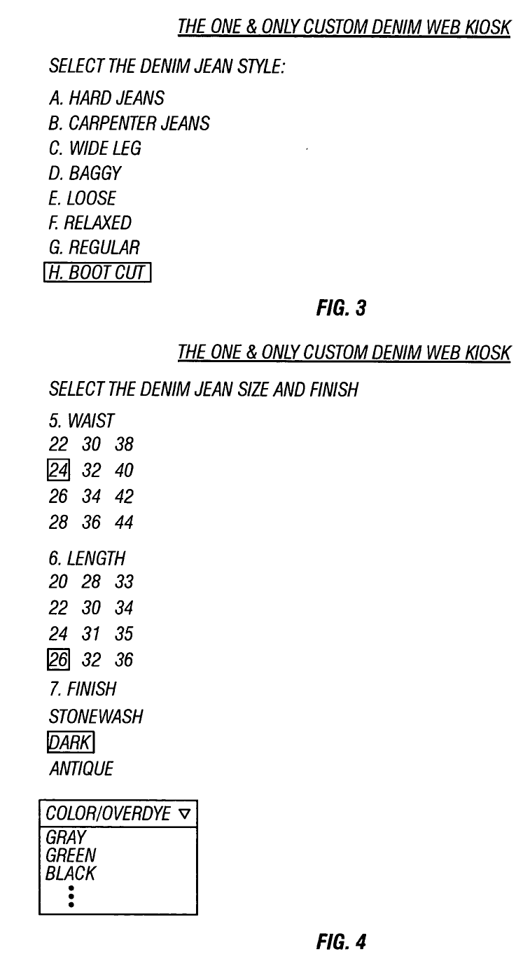

The customer first selects the clothing type of denim product to customize from the menu shown in FIG. 2, from the menu allowing jeans, shorts, shirts, jackets. Of course, any of the different apparel types that the manufacturer can manufacture can be listed.

Completion of the function calls up the jean style menu shown in FIG. 3. The type of denim product can include style, e.g., boot cut, regular, relaxed, loose, baggy, wide leg, carpenter jeans, or hard jeans.

Completion of the function calls up the size menu, shown in FIG. 4. The user selects the waist size, jean length, and finish. The finish can be stonewash, dark, antique or an overdyed color selected from a pull-down menu.

Receiving computer 120 now has enough information to begin to echo back a picture of the apparel. FIG. 3 illustrates the user having selecting the specific style of jeans such as Aboot cut@. Waist size, length and finish options are then selected as shown in FIG. 4. FIG. 5 illustrates the picture that is provided by the programming in the receiving computer. The receiving computer provides the diagram shown in FIG. 5, which shows the front and back of the apparel on the screen. The picture that is provided corresponds generally to the selection—here jean pants, boot cut.

FIG. 5 allows the user to selection of the area to apply the desired graphic. The user can actually choose where on the front or back of the denim jean he or she would like the graphic to be scribed. The example in FIG. 5 shows that the user has selected the right front ankle section to scribe the graphic. This causes the receiving computer to display a default-sized graphics box to receive the graphic being displayed. That box can be sized by the user at the remote terminal, e.g., by dragging corners of the box to enlarge or contract it.

The menu also allows the user to globally select all, to command that a wallpaper formed from the selected graphic be repetitively formed on the denim.

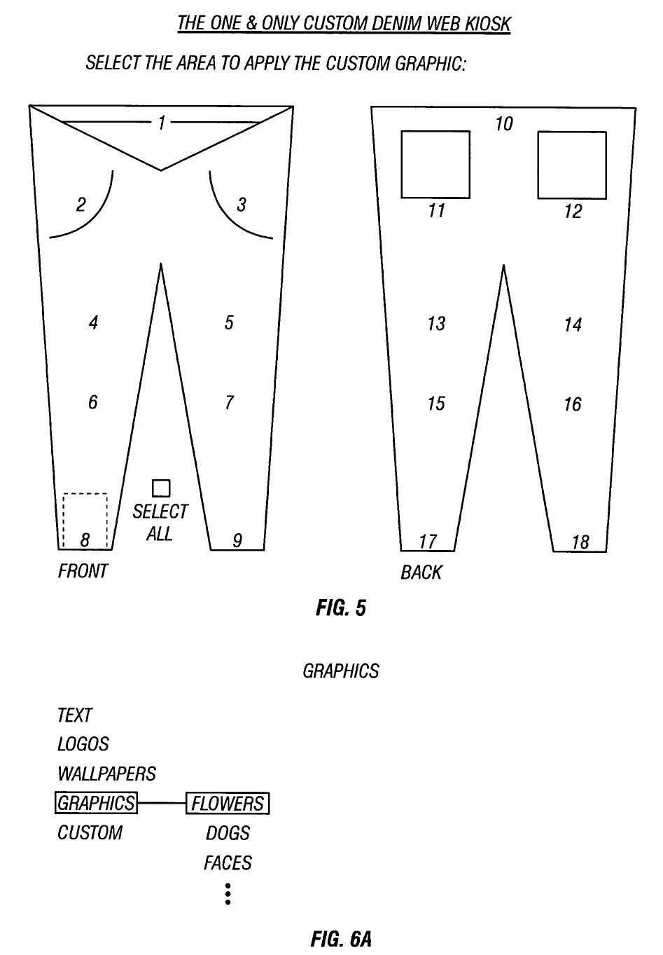

The user then selects a graphic to be formed on the denim. FIG. 6A shows the categories of graphics that can be selected. The user can select from text, Logos, wallpapers, graphics, or custom. Each selection brings up at least one other submenu, including further subcategories and/or choices.

The text selection can bring up font and point menus, as described later herein.

Logos can bring up a library of prestored logos, licensed from different sources, e.g., professional sports logos, science fiction theme or comic book logos, or the like. If any logo is licensed from a source that requires a fee for its use, then the fee is included within the price calculation as explained herein.

Wallpapers allow the user to select different kinds of design to cover the entirety of the denim, e.g. simulated sandblast, or other custom designs for new designs on denim. These new designs are described in our provisional application Nos. 60/102,363 and 60/102,525, the disclosures of which are herewith incorporated by reference. Graphics can include any of a multitude of different libraries of images. FIG. 6A shows selecting graphics, and the user then gets a submenu to select from a menu of choices of the categories of graphic images to form on the denim. Any number of submenus can be displayed. For example, the selection of Agraphics@ in FIG. 6A might bring up the subcategories, Aircraft, animals, arrows, birds, borders, crests, designs, dinosaur, fish, flowers, horoscope, indian designs, local abrasion, ship, space, sports. For the example in FIG. 6A, the user has chosen Flowers.

Another option, labelled as Acustom@, may allow the user to upload a custom graphic image to be scribed.

FIG. 6B shows the next screen shot in the sequence in which the library of the selected graphic, here flowers, is displayed. The user selects one of the graphics to be placed onto the garment.

The graphic images in FIGS. 6A and 6B can also include images of different wearing looks, and described in our other applications. This can include custom work looks on the garment, including stonewash, acid wash, herring bone worn or the like.

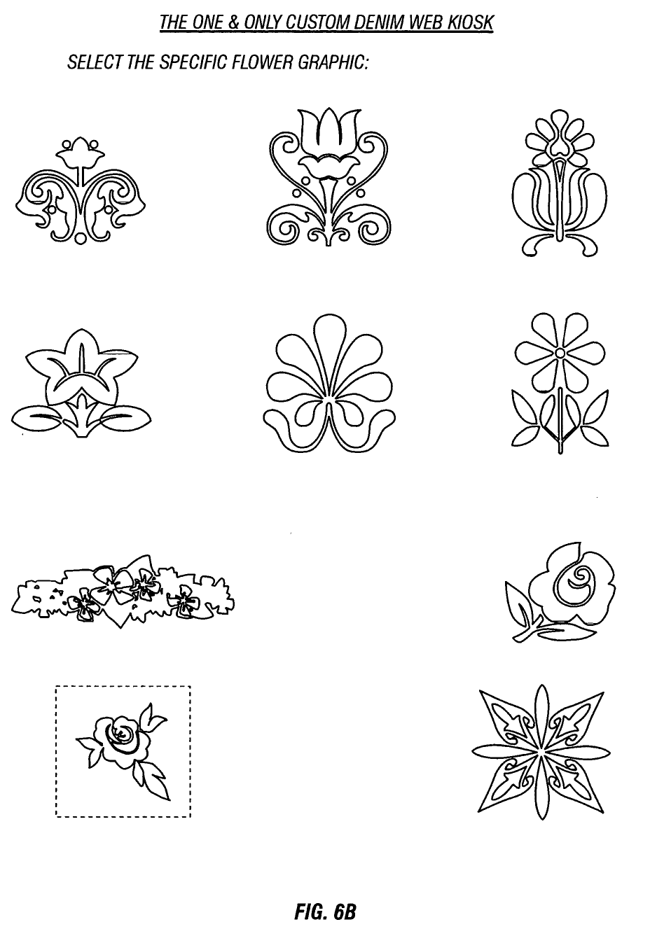

FIG. 7 is the next element in the series, where the selected graphic is shown simulated on the jeans. The user can also modify the graphic and its location by dragging the graphic to a different location on the jeans, and/or dragging the edge of the image to enlarge or contract the image.

At this time, additional items can be added by clicking the more key, in which case the flow returns to FIG. 4 to allow another graphic to be added, either in a different location or overlaid on the first graphic.

If the user does not like the look of the garment in FIG. 7, the user can click on the graphic, and enter Aremove@ to remove it. Then the garment is again displayed with the new look, that is without the selected graphic, but with the other graphics that were not selected still in place.

Each iteration allows the user to see a simulated apparel with the new designs thereon.

When the user is satisfied, the FINISH button is pressed. The receiving computer 120 calculates the total price for the apparel. This total price can include a base price for the apparel/style, and any extra charges for custom graphics, colors, logos etc that have been added.

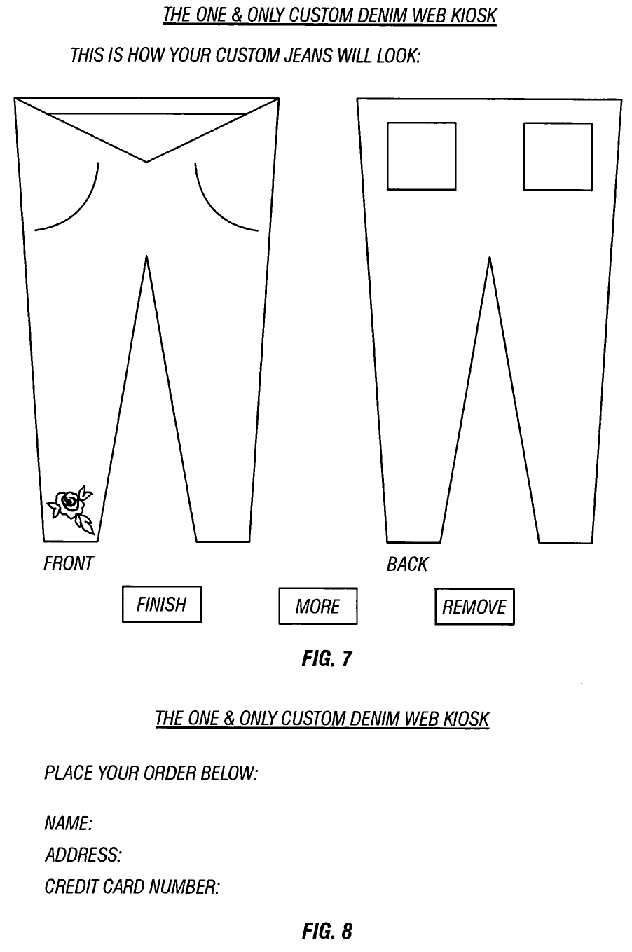

FIG. 8 allows the user to place the order by providing his or her name and address and credit card information. The FIG. 8 screen is used when operating by Internet. A different screen would be displayed for use as a point of sale in a store, e.g., printing a receipt to be taken to the cashier and paid at the cashier.

The order is then sent to a central location for processing. Preferably the garment is formed by laser-etching the desired designs in the garment, as described in our copending applications Ser. Nos. 08/844,114 and 08/729,493. The central location can be regional or national. It preferably includes a numerical controlled laser system that can custom form apparel based on the specifications entered into the receiving computer from the remote computer over the data link.

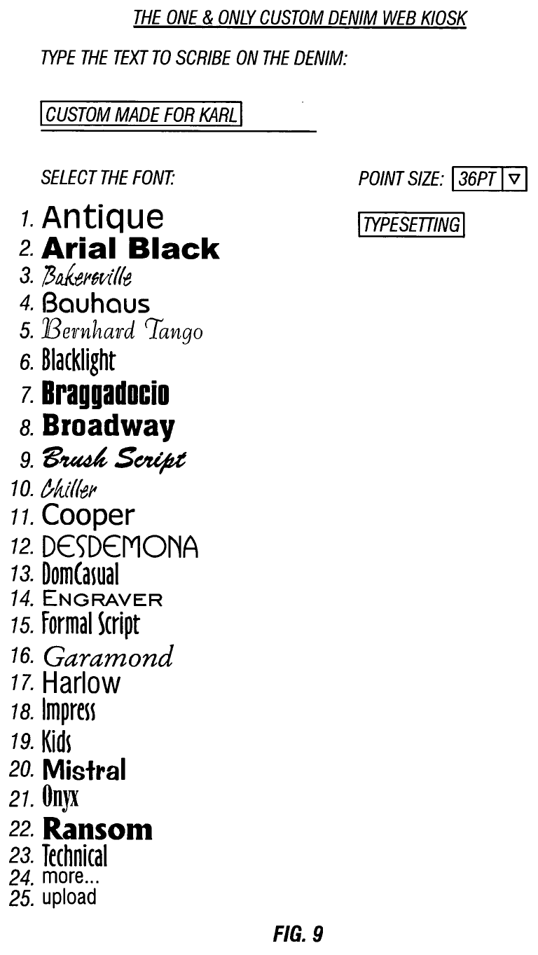

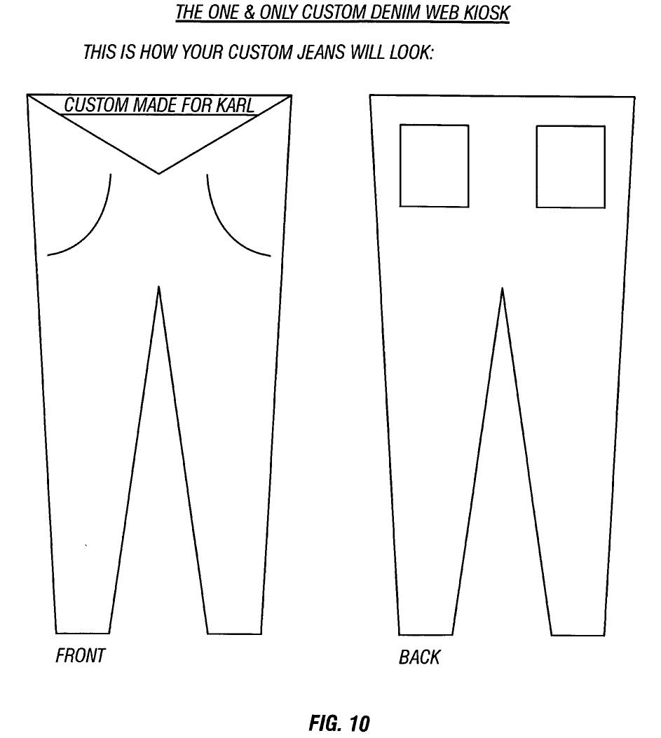

Different selections can be made from the different screens to obtain different results and displays on the remote computer. A second embodiment, representing different selections having been made, is described with reference to FIGS. 9-10.

The user selects the type of denim product from FIG. 2, the jean style from FIG. 3, the waist size, length and finish, from FIG. 4, to get the display shown in FIG. 5. The user identifies the location on the front or back of the jean to place the graphic. In this embodiment, the user is selects text from the menu of FIG. 6A. This brings up the menu of FIG. 9.

The Atext@ menu of FIG. 9 allows the user to type the text that they want scribed on the denim apparel. Here the user has typed ACustom made for Karl@. After selecting the specific text he or she wants scribed on the waistband, the user selects the specific font from a list of most popular fonts. The user is also presented with the option of getting more font choices, and the ability to upload a font, e.g., a true type font.

FIG. 9 also allows selecting point size from a pull-down menu which includes the recommended size, and also includes other sizes. Sizes which are too small to print reliably are not indicated as options on the pull-down menu.

FIG. 9 also has a typesetting button that brings up a menu of advanced text options, such as kerning, and other such options.

FIG. 10 shows the finished custom jean. As in FIG. 7, the user can use the display to determine if they are satisfied. Portions can be selected and removed, selected and resized or moved, and/or additional portions can be added. Each such change and/or deletion is followed by a redisplay at FIG. 10 with the new look of the apparel to allow the user to see the new look and decide if they like it.

This allows regional or a central distribution center to be equipped with the laser scribing technology. Orders from the Web Kiosk are electronically transmitted to one of these distribution centers, which inventory the company=s denim products. The distribution center selects the proper jeans, and runs them through the custom process to form a customized pair of jeans exactly to the user=s specifications. These are then sent from the Web Kiosk and the central processing center ships the finished pair to the customer.

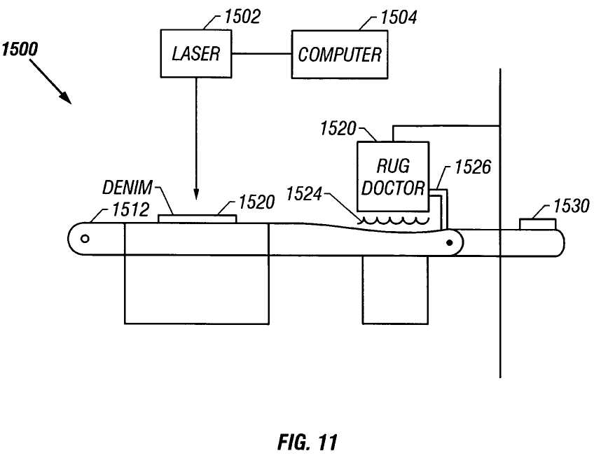

The device is scribed using the computer-driven techniques described in U.S. patent application Ser. No. 08/924,389 filed Sep. 5, 1997. This is shown in FIG. 11. Element 1500 represents the laser assembly. The laser 1502 is driven by a computer 1504, which is programmed according to the teachings of the Ser. No. 924,389 application to form the custom design and/or designs on the which is on a conveyer 1512 or the like. According to a preferred aspect, the laser assembly 1500 is also used to form a simulated label on the denim, e.g. a label indicating the brand name of the denim, and/or a company logo.

The laser scribing leaves the denim with certain undesired remnants of the scribing technique. However, washing the apparel using a conventional wash technique could slow down throughput. Hence conveyor 1512 moves the denim to an in-line semiwashing station 1520. This can be a rug shampooer or the like that scrubs the apparel to remove the undesired artifacts therefrom. More generally, the in-line semiwashing station uses a plurality of brushes 1524 which are moistened with a soap solution. After the scrubbing, the soap material is removed by soap remover 1526, which can be a wet-type vacumn, or another rinse device.

The apparel is then ready to wear, and can be removed from the conveyer, slightly dried if necessary, and packed for shipping at 1530.

1. A method comprising:
storing apparel options on a remote computer, said apparel options including at least possible graphics for forming on an apparel, and individual prices associated with at least plural ones of said graphics;
sending said apparel options from the remote computer to a local computer over a network;
selecting customization for said apparel by using the local computer to select custom options for a desired item of said customized apparel, said custom options which are selected including one of several selected areas of said apparel, and one of said possible graphics to be formed on said selected area;
sending current custom information regarding custom apparel from the local computer to the remote computer;
producing a simulated view of said custom apparel in said remote computer based on said current custom information;
sending said simulated view of said custom apparel from said remote computer to said computer for display on said local computer;
displaying, on the computer, a simulated view of said customized apparel;
placing an order for said customized apparel from said local computer after producing said simulated view, and sending information about the order for the customized apparel from said computer to the computer; and
in said remote computer, calculating a price based on said apparel options including at least said individual prices associated with said graphics.

2. A method as in claim 1, wherein said selecting customization includes entering information about a desired type of graphic on said computer, sending said desired type of graphic to said remote computer, determining available graphics in said computer which match said desired type of graphic, sending said available graphics that match from said computer to said local computer, displaying said available graphics on said local computer, and allowing a user to select one of said available graphics for formation on said apparel.

3. A method as in claim 1, wherein said selecting customization further comprises allowing a user to upload a desired said graphic from said local computer to said server computer.

4. A method as in claim 1, wherein said desired type of graphic includes one of a text or a picture type.

5. A method as in claim 1, wherein said graphic is text, and further comprising selecting some attribute of said text, including size of said text and/or font of said text.

6. A custom apparel producing device, comprising:
a processor, associated with a memory storing custom apparel information, and programmed to run a series of instructions which obtain information for selection of custom apparel from said memory, said processor programmed with instructions which cause certain information from said memory to be sent over a network to a remote user and allows the remote user to select custom apparel information from among said custom apparel information in said memory, and to return the custom apparel information to said processor as customized apparel information;
a programmable laser device, programmed according to said customized apparel information obtained via said processor, and configured to process an item of apparel using a laser beam according to said information, to alter said item of apparel according to said information in a way that leaves at least one material remnants after processing.

7. A device as in claim 6, wherein said data link is the Internet.

8. A device as in claim 6, wherein said processing is programmed to receive information indicative of at least one graphic item to customize said apparel, said information indicative of said at least one graphic item coupled to said programmable laser device to cause said laser beam to alter said item of apparel according to said at least one graphic item, to leave a view of said at least one graphic item on said apparel, and wherein said processor includes prices associated with at least a plurality of said graphic items, and calculates a total price for a customized item including said prices for said graphic items.

9. A device as in claim 8, wherein said graphic item is one of text or a picture.

10. A device as in claim 8, wherein said programmable laser device includes a conveyor, and further comprising washing said denim material on said conveyor by using brushes and a soap material, and also removing said soap material after washing.

11. A method comprising:
using a first computer to select a customized apparel and provide information indicative of the customized apparel to a remote computer which is remote from said first computer;
storing information about apparel customization including at least a plurality of different apparel styles, and a plurality of different available graphic information that can be formed on said apparel, on the remote computer;
sending information indicative of said available graphic information from said remote computer to said first computer;
displaying options for said information on the first computer;
selecting customization for said apparel by using the first computer to select both of a selected area of said apparel to be customized, and a graphic to be formed on said selected area;
requesting said first computer to move said graphic from said selected area to another selected area as a new selected area;
determining when customization is complete; and
sending information indicative of both of said selected area and said graphic to the remote computer over network.

12. A method as in claim 11, wherein said network is the Internet.
